(19) United States
(12) Patent Application Publication
(10) Pub. No.: US 2025/0251126 A1
(43) Pub. Date: Aug. 7, 2025

(54) BALLOON LAMP WITH REPLACEABLE AIR FILTER DEVICE

(71) Applicant: SHENZHEN YONGXINRUI LIGHTING TECHNOLOGY CO., LIMITED, Shenzhen (CN)

(72) Inventor: Liang Guo, Zigong (CN)

(73) Assignee: SHENZHEN YONGXINRUI LIGHTING TECHNOLOGY CO., LIMITED, Shenzhen (CN)

(21) Appl. No.: 18/958,044

(22) Filed: Nov. 25, 2024

(30) Foreign Application Priority Data
Feb. 1, 2024 (CN) 2024202440344

(51) Int. Cl. F21V 33/00; F21V 3/02; F21V 3/06; F21V 31/00

(52) U.S. Cl. CPC F21V 33/0096; F21V 3/026; F21V 3/06; F21V 31/005

(57) ABSTRACT

Disclosed is a balloon lamp with a replaceable air filter device, which includes a lamp body and a fabric lamp cover, the fabric lamp cover is installed on the lamp body, a bottom of the lamp body is fixedly mounted with a lamp base, and an inflation fan for injecting air into an interior of the fabric lamp cover is fixedly mounted on the lamp base; a filter for filtering the air at an air inlet end of the inflation fan is detachably assembled on the lamp base; an air outlet is formed in a middle part of the lamp base, air inlets are formed on both sides of the lamp base, and the air inlets penetrate through the air outlet; and a sealing strip is arranged between the inflation fan and the lamp base, and a bottom of the inflation fan corresponds to the air outlet.

### TECHNICAL FIELD

The present disclosure relates to the technical field of balloon lamps, and particularly relates to a balloon lamp with a replaceable air filter device.

### BACKGROUND

Since existing lamps always have fabric covers, dust, impurities, and other airborne particles may enter the fabric covers, lighting effects and service lives of the lamps are accordingly reduced. Traditional air filters are usually hard to be disassembled and replaced, making maintenance and cleaning difficult. The accumulation of dust in the air filters over time weakens air inflation effects of the fabric covers, and also reduces an air circulation speed inside the lamps, the heat dissipation of radiators thereof is affected, and the service lives of lamps are further reduced.

Therefore, a removable and replaceable air filter device is required to make a filter device easier to be replaced and cleaned, so as to improve the performance and reliability of a lamp.

### SUMMARY

An objective of the present disclosure is to provide a balloon lamp with a replaceable air filter device, so as to solve the problems mentioned in the background.

In order to achieve the above objective, the present disclosure adopts the following technical solution:
a balloon lamp with a replaceable air filter device, including a lamp body and a fabric lamp cover, where the fabric lamp cover is installed on the lamp body, a bottom of the lamp body is fixedly mounted with a lamp base, and an inflation fan for injecting air into an interior of the fabric lamp cover is arranged on the lamp base; and
a filter for filtering the air at an air inlet end of the inflation fan is also arranged on the lamp base, and the filter is detachably assembled on the lamp base.

In a preferred embodiment of the present disclosure, an air outlet is formed in a middle part of the lamp base, air inlets are formed on both sides of the lamp base, and the air inlets penetrate through the air outlet.

In a preferred embodiment of the present disclosure, the inflation fan is fixedly mounted on the lamp base, a sealing strip is arranged between the inflation fan and the lamp base, and a bottom of the inflation fan corresponds to the air outlet.

In a preferred embodiment of the present disclosure, the filter is arranged on a flat plate, both ends of the flat plate is provided with pull-out plates, a notch is formed at a lower right end of the flat plate, the pull-out plates are arranged inside the air inlets, and the filter corresponds to the air outlet.

In a preferred embodiment of the present disclosure, an end of the lamp base is provided with a first internal threaded hole, the flat plate is provided with a second internal threaded hole, and the lamp base is fixedly connected to the flat plate through a screw passing through the first internal threaded hole and the second internal threaded hole.

In a preferred embodiment of the present disclosure, the filter is made from high-efficiency filter material, and is set as a high-efficiency particulate air filter.

Additional aspects and advantages of the present disclosure will be set forth partially in the following description, which will become obvious in the following description, or may be learned by practice of the present disclosure:
1. improving the lighting effects of the lamp: the filter effectively prevents dust, impurities, and other airborne particles from entering the interior of the fabric lamp cover, keeping the fabric lamp cover clean and improving the lighting effects of the lamp;
2. extending the service life of the lamp: the filter prevents the accumulation of impurities on the light source and other lamp components, reducing the frequency of maintenance and replacement, thereby extending the service life of the lamp; and
3. providing a healthier lighting environment: the filter can filter harmful substances in the air, providing a healthier lighting environment and reducing potential health hazards to the user.

### BRIEF DESCRIPTION OF THE DRAWINGS

What is described above and/or additional aspects and advantages of the present disclosure will become apparent and easy to understand from the following description of the embodiments in combination with the drawings below.

FIG. 1 is a perspective view of a balloon lamp with a replaceable air filter device according to the present disclosure.

FIG. 2 is a schematic diagram of a fixed state of a filter in a balloon lamp with a replaceable air filter device according to the present disclosure.

FIG. 3 is a schematic diagram of a disassembled state of a filter in a balloon lamp with a replaceable air filter device according to the present disclosure.

Reference numerals in the accompanying drawings: 1. fabric lamp cover; 2. lamp body; 3. lamp base; 4. air outlet; 5. scaling strip; 6. inflation fan; 7. air inlet; 8. pull-out plate; 9. flat plate; 10. notch; 11. filter; and 12. screw.

### DETAILED DESCRIPTIONS OF THE EMBODIMENTS

Embodiments of the present disclosure are described in detail below, examples of the embodiments are shown in accompanying drawings, throughout which identical or similar reference numerals denote identical or similar elements or elements having identical or similar functions. The embodiments described with reference to the accompanying drawings are exemplary and only intended to explain the present disclosure, instead of being interpreted as limiting the present disclosure.

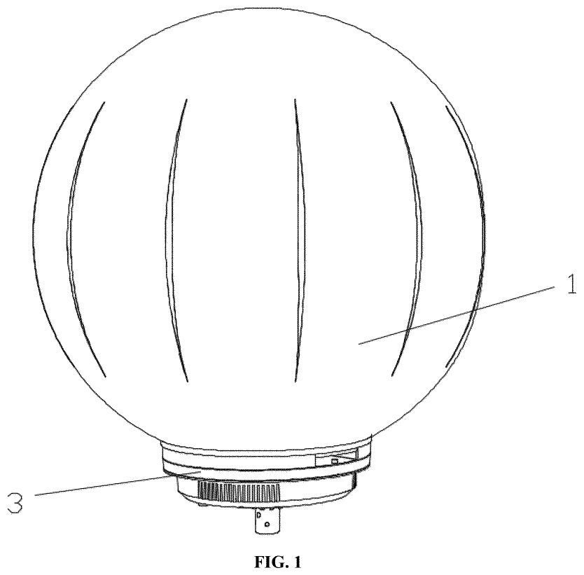

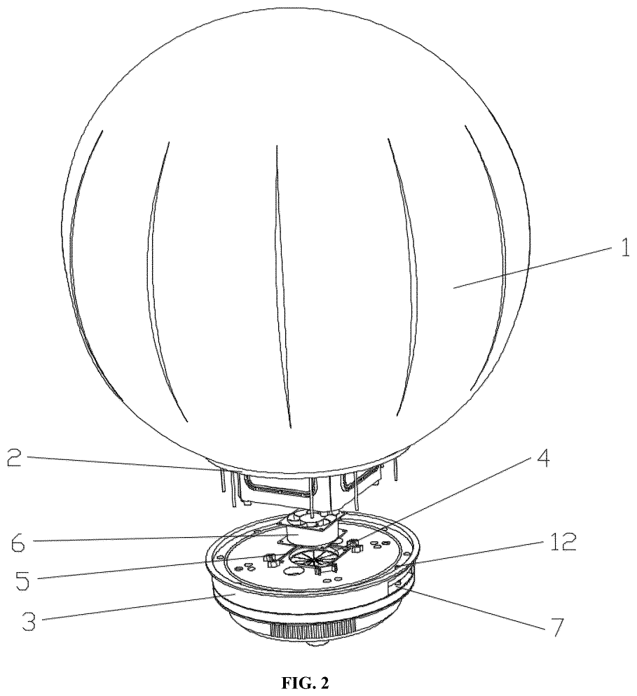

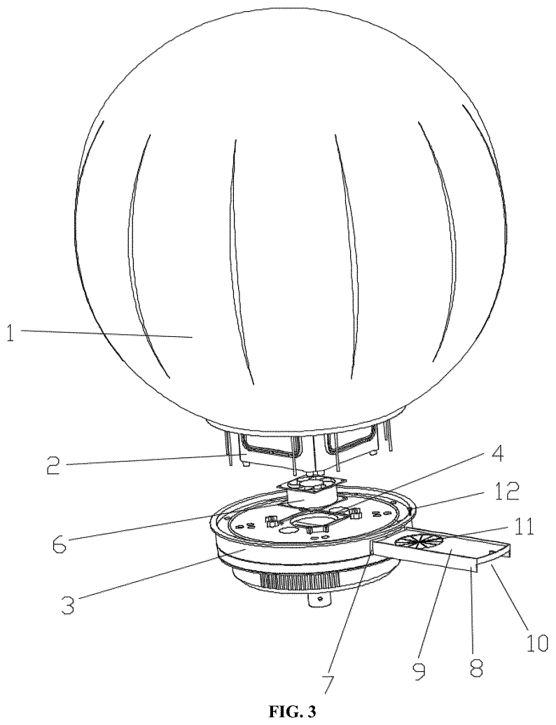

As shown in FIGS. 1-3, a balloon lamp with a replaceable air filter device includes a lamp body 2 and a fabric lamp cover 1, where the fabric lamp cover 1 is installed on the lamp body 2, a bottom of the lamp body 2 is fixedly mounted with a lamp base 3, and an inflation fan 6 for injecting air into an interior of the fabric lamp cover 1 is arranged on the lamp base 3; a filter 11 for filtering the air at an air inlet end of the inflation fan 6 is also arranged on the lamp base 3, and the filter 11 is detachably assembled on the lamp base 3; and the filter 11 is arranged inside an air inlet channel of the inflation fan 6 for filtering dust, impurities, and the like, in the air;

an air outlet 4 is formed in a middle part of the lamp base 3, air inlets 7 are formed on both sides of the lamp base 3, and the air inlets 7 penetrate through the air outlet 4; the air inlets 7 are located on both sides of the lamp base 3, the air inlets 7 are configured to introduce air into the inflation fan 6 and the filter 11, and size and position of the air inlets 7 can be properly set to ensure effective introduction of air without affecting normal lighting of the lamp; and the air outlet 4 is located between the inflation fan 6 and the filter 11, the air outlet 4 is configured to release filtered air into the interior of the fabric lamp cover 1, the filter 11 is in close contact with the air outlet 4, and the air outlet 4 is located at an exact center of the lamp base 3, so as to ensure that the filtered air is evenly distributed to all areas of the fabric lamp cover 1;

the inflation fan 6 is fixedly mounted on the lamp base 3, a sealing strip 5 is arranged between the inflation fan 6 and the lamp base 3, and a bottom of the inflation fan 6 corresponds to the air outlet 4; the filter 11 is arranged on a flat plate 9, both ends of the flat plate 9 is provided with pull-out plates 8, a notch 10 is formed at a lower right end of the flat plate 9, the pull-out plates 8 are arranged inside the air inlets 7, and the filter 11 corresponds to the air outlet 4; and the filter 11 is detachably connected to the inflation fan 6 and the air inlets 7, and by removing a single fixing screw of the filter 11, the filter 11 can be easily taken out from the air inlets for replacement; and

an end of the lamp base 3 is provided with a first internal threaded hole, the flat plate 9 is provided with a second internal threaded hole, and the lamp base 3 is fixedly connected to the flat plate 9 through a screw 12 that passes through the first internal threaded hole and the second internal threaded hole; and the filter 11 is made from high-efficiency filter material, and is set as a high-efficiency particulate air filter.

The working principle of the present disclosure is as follows: the lamp body 2 is removed from the lamp base 3, the pull-out plates 8 are then inserted into the air inlets 7, the flat plate 9 is fixed onto the lamp base 3 using the screws 12, and the inflation fan 6 is electrically connected to a power supply unit and a control unit inside the lamp base 3; and when the inflation fan 6 is then powered on, air will be injected into the interior of the fabric lamp cover 1 through the air inlets 7 and the filter 11.

Although the embodiments of the present disclosure have been shown and described, it should be understood that those of ordinary skill in the art may make various changes, modifications, replacements, and variations to these embodiments without departing from the principle and spirit of the present disclosure, and the scope of the present disclosure is limited by the appended claims and their equivalents.

What is claimed is:

1. A balloon lamp with a replaceable air filter device, comprising a lamp body and a fabric lamp cover, wherein the fabric lamp cover is installed on the lamp body, a bottom of the lamp body is fixedly mounted with a lamp base, wherein
an inflation fan for injecting air into an interior of the fabric lamp cover is arranged on the lamp base; and
a filter for filtering the air at an air inlet end of the inflation fan is also arranged on the lamp base, and the filter is detachably assembled on the lamp base.

2. The balloon lamp with a replaceable air filter device according to claim 1, wherein an air outlet is formed in a middle part of the lamp base, air inlets are formed on both sides of the lamp base, and the air inlets penetrate through the air outlet.

3. The balloon lamp with a replaceable air filter device according to claim 1, wherein the inflation fan is fixedly mounted on the lamp base, and a sealing strip is arranged between the inflation fan and the lamp base, and a bottom of the inflation fan corresponds to the air outlet.

4. The balloon lamp with a replaceable air filter device according to claim 1, wherein the filter is arranged on a flat plate, both ends of the flat plate is provided with pull-out plates, a notch is formed at a lower right end of the flat plate, the pull-out plates are arranged inside the air inlets, and the filter corresponds to the air outlet.

5. The balloon lamp with a replaceable air filter device according to claim 4, wherein an end of the lamp base is provided with a first internal threaded hole, and the flat plate is provided with a second internal threaded hole, and the lamp base is fixedly connected to the flat plate through a screw passing through the first internal threaded hole and the second internal threaded hole.

6. The balloon lamp with a replaceable air filter device according to claim 1, wherein the filter is made from high-efficiency filter material, and is set as a high-efficiency particulate air filter.
